(19) United States
(12) Patent Application Publication
(10) Pub. No.: US 2009/0200165 A1
(43) Pub. Date: Aug. 13, 2009

(54) USE OF POLYMER REAGENTS TO MODULATE AND CONTROL ELECTROKINETIC FLOWS IN A MICRO- OR NANOFLUIDIC DEVICE

(75) Inventors: Jan Sudor, Toulouse (FR); Françoise Vinet, Grenoble (FR); Anne-Marie Gue, Rebigue (FR); Daniel Esteve, Ramonville Saint Agne (FR)

Correspondence Address: OBLON, SPIVAK, MCCLELLAND MAIER & NEUSTADT, P.C., 1940 DUKE STREET, ALEXANDRIA, VA, 22314, US

(73) Assignees: COMMISSARIAT L'ENERGIE ATOMIQUE, Paris (FR); CENTRE NATIONAL DE LA RECHERCHE SCIENTIFIQUE, Paris (FR)

(21) Appl. No.: 11/994,267

(22) PCT Filed: Jun. 28, 2006
(86) PCT No.: PCT/FR06/01496

§ 371 Date: Jul. 18, 2008

(30) Foreign Application Priority Data
Jul. 1, 2005 (FR) 05 07014

(51) Int. Cl. B01D 57/02

(52) U.S. Cl. 204/451; 204/601

(57) ABSTRACT

The invention concerns the field of microfluidics and in particular that of electrophoresis on a micro- or nanofluidic device. More particularly, the invention concerns the use of a reactive polymer coating adapted to be submitted to a phase separation under the influence of an external stimulation of chemical or physical type, to modulate the electrokinetic flows (electroosmotic or electrophoretic flows during electrophoresis for example) in a micro- or nanofluidic device. The invention also concerns a method for varying the electrokinetic flows in such a device using said coating, as well as the micro- or nanofluidic devices comprising at least one channel or one capillary tube whereof the inner surface is covered at least partly with such a coating.

The present invention relates to the field of microfluidics, and in particular to that of electrophoresis on a micro- or nanofluidic device.

It relates more particularly to the use of a reactive polymer coating capable of undergoing a phase separation under the influence of an external stimulation, in order to modulate the electrokinetic flows (electroosmotic and electrophoretic flows during an electrophoresis, for example) in a micro- or nanofluidic device, to a method for varying the electrokinetic flows in such a device using said coating, and to the micro- or nanofluidic devices comprising at least one channel or one capillary tube, the inner surface of which is covered at least partly with such a coating.

When electrophoresis is performed, the movement and subsequent separation of charged objects is brought about by the application of an electric field. Originally, electrophoresis was carried out on nonconvective supports such as porous paper or else polyacrylamide or agarose gels. More recently, this powerful separation technique has adopted new geometries which have led to the creation of capillary electrophoresis or electrophoresis on microchips (Grossman, P. D. et al., “Capillary Electrophoresis, Theory and Practice”, 1992, Academic Press, San Diego).

Capillary electrophoresis is an analytical method for separating charged or neutral molecules under the influence of an electric field inside a capillary tube. An evolution of this technique is that of performing the separation on a microchip, thereby making it possible to drastically accelerate the analysis time and to reduce it to a few seconds. When charged objects, such as biomolecules, are dissolved in saline solutions, the ion concentration close to the surface of said charged objects, i.e. at the liquid-solid interface, is disturbed (attraction of counterions to the surface and repulsion of co-ions). The counterions which are very close to the charged molecules adsorb to their surface and form what is conventionally known as a Stern layer. This layer is static by nature and its thickness, also known as Bjerrum length (l_{B}) corresponds to the following equation (eq. 1):

l_{B}=e²/4π∈_{b}∈₀k_{B}T (eq. 1)

in which e is the charge of an electron, ∈₀ is the permittivity of the vacuum, ∈_{b} is the dielectric constant of the liquid, k_{B} is the Boltzman constant and T is the absolute temperature. Further from the surface, the counterions, although they are still attracted by the surface, are more mobile and form what is conventionally known as a diffuse layer. The equilibrium between the organization of the electrostatic forces and the random distribution of the thermal forces results in the formation of a double electric layer (also known as the Debye-Hückel layer) beyond which the charge of the object is neutralized. The drop in surface charge (ψ) is described, for weakly charged objects, by the following equation (eq. 2) (Debye-Hückel equation):

ψ_{(y)}=ψ_{z}e^{-KY} (eq. 2)

in which K⁻¹ is the length or the thickness of the double electrical layer (also known as Debye length) and ψ_{z} is the surface charge (or zeta potential). The Debye length is the most important length scale in the electrokinetic field. It is inversely proportional to the square root of the concentration of electrolyte in the solution (K⁻¹≈C^{-1/2}). K⁻¹ is of the order of a few nanometers in standard physiological buffers and can reach values ranging up to 1 μm in pure water at pH 7.

When an electric field (E) is applied to a saline solution, containing charged molecules (with a charge q and a diameter R), the electric force acts on the charged molecules, which will migrate to the electrode of opposite charge (electrophoretic flow). The total velocity (v) of the charged molecules is proportional to the electric force applied and inversely proportional to the friction forces between the charged molecules and the solvated counterions. Given that the solution is charged only at the sides of the double electric layer (outside this double electric layer, the electrophoretic solution is neutral), all the friction forces dissipate in this region. Consequently, the thickness of the double electric layer considerably influences the velocity of the charged molecules.

For small molecules (K⁻¹>>R), the electrophoretic mobility (μₑₗ) is calculated by the following equation (eq. 3):

μₑₗ=v/E=q/6πηR (eq. 3)

in which η is the viscosity of the aqueous solution of electrolytes.

Conversely, the electrophoretic mobility becomes independent of the size of the charged molecules in the case of molecules of greater size (K⁻¹<<R) since the electric force and the friction force are both proportional to the size of the molecules. In this case, the electrophoretic mobility is calculated by the following equation (eq. 4):

μₑₗ=∈_{b}∈₀ψ_{z}/η (eq. 4)

Consequently, uniformly charged molecules of large size, such as, for example, oligonucleotides that are longer than 15-mers, DNA, uniformly charged proteins and polysaccharides, migrate in electric fields at speeds which do not depend on their size.

Moreover, the dispersion (σ²) of the sample in the electrophoresis solution is governed by a simple diffusion and can be calculated by the following equation (eq. 5):

σ²=2Dt (eq. 5)

in which D is the molecular diffusion coefficient and t is the time. It should in particular be noted that, when the conductivity of the zone into which the sample has been injected is very different from the conductivity of the buffer solution used, the dispersion of the sample is then governed by what is referred to as the electrokinetic dispersion, which is different than simple diffusion. This electrokinetic dispersion is characterized by asymmetrical sample peaks.

During the electrophoresis, movement of the electrophoretic solution (aqueous solution of electrolytes) is also observed. This movement is called electroosmotic flow (EOF) (or plug-like flow). This EOF is characterized by a flat velocity profile and a purely diffusive dispersion of the sample. When an electrolyte is adjacent to the surface, this surface may be charged by means of the ionization of the chemical groups covalently bonded to said surface (in the case, for example, of glass surfaces, which produce surface groups of SiOH type and which release protons in the presence of water) or by means of adsorbed ions.

In the two cases, the surfaces are charged, although the concentration of ions close to the surface is disturbed, i.e. the counterions are attracted to the surface and the co-ions are repelled therefrom. As in the case of the charged molecules in saline solutions described above, the surface charge results in the formation of a double electric layer of a certain thickness, also called Debye thickness, K⁻¹, that can be calculated according to the following equation (eq. 6):

K⁻¹=(∈_{b}∈₀k_{B}T/2cz²e²)^{1/2} (eq. 6)

in which c is the concentration of electrolytes, z is the charge of the ions of the electrolyte and e is the charge of an electron. For diluted solutions (∈_{b}=78.49), at 25° C., this equation can be expressed as follows (eq. 7):

K⁻¹=0.304zC^{-1/2} (eq. 7)

in which C is the total concentration of electrolytes, expressed in mol/l, and K⁻¹ is expressed in nm.

When an electric field Eₑₓₜ is applied in a channel or in a capillary tube, as is the case, for example, during an electrophoresis, an electric force is established, which acts on the charge of volume in the Debye layer consisting of an excess of solvated counterions. Outside this region, the liquid is electrically neutral and the force of the electric field applied to the ions cancel each other out. However, given that a forcefield exists in the double electric layer, the local electric field which is tangential to the surface of the channel generates a force which is exerted in the mass of the fluid, said force inducing a shear and generating movement of the liquid inside the channel. This movement of liquid is called electroosmosis. The speed of the electroosmotic flow is equal to zero at the surface of the channel and increases in the vicinity of the double electric layer, and becomes constant beyond this double layer. The speed of the electroosmotic flow is proportional to the intensity of the electric field and to the surface potential (zeta potential) and inversely proportional to the viscosity of the liquid in the double electric layer; it does not depend on the diameter of the channel as long as the diameter d is much larger than the thickness of the double electric field (d>>K⁻¹). Of course, this applies to most microfluidic systems in which the diameter of the channels or of the capillary tubes is normally of the order of a micron, whereas the thickness of the Debye layer is of the order of a nanometer.

However, capillary electrophoresis or electrophoresis on a microchip comprises a certain number of not insignificant drawbacks. It is in particular very sensitive both to the chemistry of the solution and to the chemistry of the surface of the capillary tube or of the microchip. This often has the effect of producing changes in flow during the analysis, which compromise the reproducibility and quantification. In the case of analytical methods requiring the implementation of several integrated steps in the same micro- or nanofluidic device, uncontrolled and unexpected changes in electroosmotic flow can result in the method failing.

It is therefore necessary to be able to very precisely regulate the electroosmotic flow in analytical micro- or nanofluidic devices so as to compensate for unwanted variations therein, and in particular to prevent reduction thereof.

The control of electroosmosis is therefore an important task, in particular during electrophoretic separations, insofar as the magnitude and the direction of the electroosmotic flow affect the actual mobility of the analytes in the system. As was fully explained above, the electroosmotic flow is in fact influenced by the presence of the Debye layer present at the solid/liquid interface and is dependent on the physicochemical properties of the surface and of the electrolyte composition. Water is the solvent normally used in capillary electrophoresis (CE). The characteristics of the electroosmotic flow in the silica glass capillary tubes normally used in these aqueous systems are well known. The electroosmotic flow (EOF) in the silica glass capillary tubes is directed toward the cathode and the magnitude depends on the pH of the buffer and on its concentration. It is possible to vary the EOF by adding surfactants for the electrolyte. However, this approach has a certain number of drawbacks insofar as it requires changes in the composition of the aqueous solution of electrolytes which are not always permitted, or reversible; it is also difficult to implement dynamically during the analysis.

One of the most effective ways to vary the EOF in micro- or nanofluidic systems, and in particular in capillary electrophoresis devices, is to chemically modify the surface of the capillary tubes by applying appropriate surface coatings. Numerous reports in fact make reference to less reduction in the electroosmotic flow and also a decrease in the adsorption of solutes onto the inner walls of the capillary tubes when various surface coatings of chemical nature are used. The coatings of chemical nature commonly consist of neutral or charged, hydrophilic polymer brushes. In order to eliminate EOF in CE, a coating consisting of neutral polymer brushes is generally used. Such polymer brushes significantly increase the viscosity of the solution in the double electric layer and hydrodynamically couple this double electric layer with the rest of the solution.

It has thus already been proposed, in order to reduce EOF, to use a noncrosslinked linear polyacrylamide attached to the walls of the capillary tube by means of an organosiloxane-type reactant (Hjertén S., J. Chromatogr., 1985, 347, 191-198). However, the polymer brushes used and studied by this author are passive and do not respond to external stimulations such as light, temperature or pH.

Still along the same lines, other authors have recommended the use of polymer brushes for decreasing EOF. For example, Bruin G. J. M. et al. (J. Chromatogr., 1989, 471, 429-436) have used thin polyethylene glycol (PEG)-based coatings so as to partially reduce EOF and for minimizing protein adsorption onto the capillary tube walls. They indicate, however, that such a coating does not make it possible to completely eliminate EOF, nor protein adsorption, in particular when the CE is carried out at high pH values (pH>5).

Nashabed W. and El Rassi Z. (J. Chromatogr. A, 1991, 559, 367-383) describe the preparation of silica glass capillary tubes comprising hydroxylated polyether functions bound to the inner surface of the walls and their use for separating proteins by CE. According to a first approach, the hydrophilic coatings consist of two layers: an undercoat of glyceropropylpolysiloxane (covalently bonded to the inner surface of the capillary tube) and a surface coat of polyether type. According to a second approach, the capillary tube wall is coated with polyether-polysiloxane chains covalently attached to the inner surface of the capillary tube. The authors indicate that these coatings make it possible to reduce solute adsorption onto the walls, while at the same time being stable and having separative properties, thus resulting in reliable and reproducible results.

Other authors have recommended modifying the inner surface of capillary tubes with passive polymer coatings obtained:
from epoxy polymers covalently bonded to silica by means of a glycerolpropylsilane arm (coating limiting interactions with proteins by steric hindrance due to the presence of the silanol groups);
from polyvinylmethylsiloxanediols crosslinked and then coated with a layer of linear polyacrylamide attached by means of double bonds to the siloxanediol; the polyacrylamide being finally crosslinked with formaldehyde (static neutral coating);
from polyvinyl alcohols (PVAs) which make it possible to produce permanent coatings which are stable over a wide pH range and which can be used for separating glycoproteins;
from homopolymers simply adsorbed onto the inner surfaces of the capillary tubes, such as PVA, polydimethylacrylamide (PDMA), polyethylene oxides (PEOs) and polyvinylpyrrolidone (PVP), and producing layers of polymers with a fractal structure; the most effective polymer for eliminating EOF being PDMA (Madabhushi R. S., Electrophoresis, 1998, 19, 224-230).

All these polymers have, however, the drawback that they produce passive coatings, i.e. coatings for which it is not possible to vary the properties under the action of an external stimulation.

For several years, various types of surfaces grafted with reactive polymer brushes, i.e. capable of reacting and of becoming modified in response to an external stimulus, have been studied. These reactive polymer brushes may, for example, be obtained from polymers of poly(N-isopropylacrylamide) type (PNIPAM) which undergo a phase transition (coil-globule) at their lower critical solution temperature (LCST) which is approximately 32° C.±1 to 2° C. in the pure state in water (Heskins, M. et al., J. Macromol. Sci. Chem., 1968, A2, 1441 and Schild, H. G., Prog. Polym. Sci. 1992, 17, 163). As a result, the surfaces coated with such a polymer have temperature-dependent properties, such as the wettability and the thickness of the coating. It has, however, been demonstrated that the behavior of PNIPAMs grafted onto surfaces, as a function of the temperature (in particular the phase separation), is substantially different from the behavior of these same polymers in solutions. The grafted polymers are commonly elongated when the grafting density is sufficiently high. Surfaces modified with a PNIPAM-based coating have been used for varied applications. For example, silica beads modified with a copolymer containing PNIPAM have been used as a stationary phase for temperature-controlled liquid phase chromatographic separations (Kanazawa, H. et al., Anal. Chem. 1996, 68, 100-105). Magnetic particles functionalized with PNIPAM have been used in controlled protein adsorption and desorption experiments (Elaissari A. et al., Magnetism and Magnetic Materials, 2001, 225, 151-155). Planar surfaces comprising grafted polymers of PNIPAM type have also been used as a cell culture support (Aoki T. et al., J. Biomater. Sci. Polym. Ed., 1995, 7, 539-550) and in tissue engineering (Yamamoto M. et al., Tissue Eng., 2001, 7, 473-480).

However, at this time, there exists no micro- or nanofluidic device in which it is possible to simply and reversibly vary and control the electrokinetic flow.

The inventors have therefore developed what is the subject of the present invention in order to remedy all the drawbacks of the micro- and nanofluidic devices currently available and to provide a technical solution for readily, rapidly and reversibly regulating electrokinetic flows during the performing of an analysis in a micro- or nanofluidic device.

For the purpose of the present invention, the term “regulation” is intended to mean an increase, decrease or disappearance of electrokinetic flows, from the static and dynamic, and spatial and temporal point of view.

The inventors have in particular noted, surprisingly, that, under certain conditions, the grafting of a coating onto at least a part of the inner surface of a channel of variable geometry or of a capillary tube of a micro- or nanofluidic device makes it possible to respond to this technical problem when said coating is obtained from flexible polymers capable of undergoing phase separation in an aqueous solution (reversible separation: coil-globule transition).

This technical solution forms the basis of the present invention.

A first subject of the present invention is therefore the use of a reactive polymer coating grafted onto at least a part of the inner surface of a channel or of a capillary tube of a micro- or nanofluidic device containing at least one aqueous solution of electrolytes, said surface comprising electrically charged chemical groups forming a double electric layer at the liquid-solid interface, said coating having the following characteristics:

a) it consists of a layer of flexible polymers capable of undergoing phase separation (coil-globule transition) in an aqueous solution under the influence of an external stimulation of physical or chemical nature,
b) the polymers are covalently grafted onto said surface via just one of their ends,
for reversibly modulating and controlling the electrokinetic flows in said device by varying the viscosity of the aqueous solution of electrolytes only in the double electric layer under the influence of an external activation of chemical or physical nature.

The inventors have in fact demonstrated that, under the influence of an external activation of chemical or physical nature, the thickness of the layer of polymers constituting the grafted coating can vary due to phase separation (coil-globule transition) of the polymers, which become more or less soluble in the aqueous solution of electrolytes. The change in thickness of the polymer coating varies the viscosity of the solution of the double electric layer present at the liquid-solid interface of the micro- or nanofluidic device, but does not vary the viscosity of the aqueous solution of electrolytes outside this zone. This change in viscosity of the solution in the vicinity of the inner surface only (of the order of a few nanometers) thus makes it possible to significantly vary the electrokinetic properties of the device or those of the charged molecules.

In particular, a decrease in the viscosity of the aqueous solution of electrolytes present in the double electric layer located at the liquid-solid interface of the micro- or nanofluidic device (low solubility of the polymers) brings about an increase in the electrokinetic flow. In this case, the polymers are referred to as “activated”, and the thickness of the polymer coating is less than the thickness of the double electric layer present at the liquid-solid interface of the micro- or nanofluidic device, thus resulting in an increase in the electrokinetic flow.

Conversely, an increase in the viscosity of the aqueous solution of electrolytes present in the double electric layer located at the liquid-solid interface of the micro- or nanofluidic device (high solubility of the polymers resulting in a polymer coating in the form of a brush of swollen polymers) brings about a decrease in the electrokinetic flow. In this case, the polymers are referred to as “inactivated”, and the thickness of the polymer coating is greater than the thickness of the double electric layer present at the liquid-solid interface of the micro- or nanofluidic device, thus resulting in a decrease in the electroosmotic flow.

For the purpose of the present invention, the expression “grafted onto at least a part of the inner surface” means that the grafting of the polymers may be carried out on an inner surface having a surface area less than or equal to the total surface area of the inner surface of the capillary tube.

According to the invention, the thickness of the double electric layer present at the interface of the electrophoresis device is generally between approximately 0.1 nm and 1 μm, preferably between approximately 0.5 and 10 nm, and even more preferably between approximately 1 and 5 nm.

The inner surface of the device may be planar, concave or micro- or nanostructured, and may consist of any solid material, the surface of which can be functionalized with chemical groups that are ionizable in an aqueous solution. Among such materials, mention may be made of glass, quartz, silica and polymer materials such as plastics.

The channel of the device may have a variable geometry. According to a preferred embodiment of the invention, the channel and the capillary tube have dimensions such that their smallest width or their diameter is greater than the thickness of the double electric layer. This dimension is preferably less than approximately 1 mm, more preferably less than or equal to approximately 0.5 mm, and even more preferably less than or equal to approximately 0.1 mm.

The chemical groups present at the inner surface of the channel or of the capillary tube are electrically charged since they are chosen from chemical groups that are ionizable in the presence of an aqueous solution. Among such groups, mention may in particular be made of silanol groups (—Si—OH) when the inner surface is a hydrated silica oxide, quartz or glass; primary, secondary or tertiary amines; sulfate, sulfonate, phosphonate and carboxylic groups. It is the presence of these charged groups on the inner surface of the device which results in the formation of the double electric layer at the liquid-solid interface.

The polymers that can be used according to the invention are covalently grafted onto the inner surface of said channel or said capillary tube, preferably by means of chemical groups chosen from silanol (—Si—OH), vinyl (CH—CH₂), carboxyl (—COOH), amino (—NH₂), epoxy (—CH—(O)CH₂), oxyamine (—O—NH₂), thiol (—SH), halide (—Br or —Cl), etc., groups.

According to a specific embodiment of the invention, the inner surface of the channel or of the capillary tube may be modified with at least two types of chemical groups of different nature. In such a case, the first type of chemical groups may be used for the covalent grafting of the polymers constituting the reactive coating, while the second type of chemical groups may serve to electrically charge the inner surface of the channel or of the capillary tube and, optionally, to attach molecules such as probe molecules of biological nature which are not sensitive to the chemical or physical activation that will be used to activate the polymer coating. In this case, when the polymers are activated and adopt a globule conformation, the probe molecules being accessible to the target molecules possibly present in the aqueous solution of electrolytes, whereas they are not accessible when the reactive polymers are not activated since they are in some way masked in the thickness of the polymer coating (polymer brush).

According to another embodiment of the invention, the grafting density of the polymer chains constituting the reactive coating is lower than the density of the surface chemical groups, irrespective of their nature. In this case, chemical groups remain free after the grafting of the polymer coating.

As was explained above, the polymers that can be used in accordance with the invention respond to an external stimulation by phase separation. Thus, when the polymers are inactivated, the thickness of the reactive polymer coating is greater than that of the double electric layer. In this case, the viscosity of the aqueous solution of electrolytes in the double electric layer is greater than that of the aqueous solution of electrolytes outside this double layer and tends toward infinity. Under these conditions, when an electric field is applied to the device, the electrokinetic flow of the aqueous solution of electrolytes (electroosmotic flow) tends toward zero.

Conversely, when the polymers are activated, the thickness of the polymer coating is less than that of the double electric layer (polymers in globular conformation). In this case, the viscosity of the aqueous solution of electrolytes in the double electric layer is equal or substantially equal to that of the aqueous solution of electrolytes outside this double layer. Under these conditions, when an electric field is applied to the device, the electroosmotic flow of the aqueous solution of electrolytes is other than zero, and proportional to the surface potential (zeta potential).

According to the invention, the grafting density of the polymers forming the coating is such that the distance separating the points of anchorage of two polymer chains on said surface is greater than, equal to or less than the radius of gyration of said chains.

According to a specific embodiment of the invention, the grafting density of the polymers is such that the polymers are in the form of a discontinuous and heterogeneous coating when the polymers are in the collapsed state (“activated” polymers) and form holes which allow the surface charges to be exposed to the aqueous solution of electrolytes.

For the purpose of the present invention, a polymer is said to be “flexible” when the theoretical length of its chain L is greater than its persistent length.

The polymers that can form the coating that can be used according to the invention may be linear or branched. They are preferably chosen from linear polymers.

The polymers that can be used in accordance with the invention can be categorized according to the nature of the activation to which they are sensitive from a conformational point of view (chemical: pH, ionic strength, for example; or physical: light, temperature, magnetic or electric field).

According to a first embodiment of the invention, the polymer coating consists of polymers chosen from polymers sensitive to an external activation of physical nature.

Among such polymers, mention may first be made of polymers sensitive to variations in temperature, i.e. the solubility of which, and consequently the three-dimensional conformation of which, varies according to variations in temperature. Within this family of polymers are, in particular, polymers of acrylamide or methacrylamide type in which the LCST can readily be varied according to the nature of the alkyl groups and among which mention may be made of poly(N-isopropylacrylamide) PNIPAM with an LCST of approximately 32° C., poly(N,N′-methylpropylacrylamide) with an LCST=approximately 14° C., poly(N-propylacrylamide) with an LCST=approximately 22° C., poly(N,N′-methylethylacrylamide) with an LCST=approximately 57° C., poly(N-propylmethacrylamide) with an LCST=approximately 28° C., poly(N,N′-isopropylmethacrylamide) with an LCST=approximately 45° C.; copolymers resulting from the copolymerization of monomers chosen from N-isopropylacrylamide, N,N′-methylpropylacrylamide, N-propylacrylamide, N,N′-methylethylacrylamide, N-propylmethacrylamide and N,N′-isopropylmethacrylamide; copolymers resulting from the copolymerization of a monomer chosen from N-isopropylacrylamide, N,N′-methylpropylacrylamide, N-propylacrylamide, N,N′-methylethylacrylamide, N-propyl-methacrylamide and N,N′-isopropylmethacrylamide, and of a monomer not sensitive to external variations of chemical or physical nature, chosen from acrylamide, N,N-dimethylacrylamide, acrylic acid and acrylamide-type monomers; and block copolymers of polyethylene oxide, of polypropylene oxide and of methylcellulose (Heskins M. et al., Macromol. Sci.-Chem. A2, 1968, 1441; Taylor L. D. et al., J. Polym. Sci.: Polym. Chem. Ed. 1975, 13, 2551-2570; Schield, H. G., Prog. Polym. Sci., 1992, 17, 163-249; Freitag R. et al., M. J. Polym. Sci.: Part A: Polym. Chem., 1994, 32, 3019-3030; Mao, H. et al., J. Am. Chem. Soc., 2003, 125, 2850-2851).

Thus, the polymer brushes constituting the reactive coating that can be used according to the invention are in a hydrated and swollen state in an aqueous solution when the temperature of said solution is below the LCST, and become hydrophobic and collapse when the temperature of the solution is above the LCST.

Among the polymers sensitive to a physical activation, mention may also be made of polymers sensitive to irradiation by light. Within this family are, in particular, polymers comprising an azobenzene unit, among which mention may, for example, be made of copolymers of N-isopropylacrylamide and of N-(4-(phenylazo)phenyl)acrylamide, and copolymers of dimethylacrylamide and of phenylazophenyl acrylate. Thus, the polymer brushes constituting the reactive coating that can be used according to the invention are in a hydrated and swollen state in an aqueous solution when they are not light-activated, and become hydrophobic and collapse after irradiation by light.

According to a second embodiment of the invention, the polymer coating consists of polymers sensitive to an external activation of chemical nature such as a variation in pH. It is thus possible to obtain a polymer coating consisting of neutral polymers in the form of a brush of swollen and hydrophilic polymers at acidic pH (or conversely at basic pH), whereas the coating collapses and becomes hydrophobic at basic pH (or conversely at acidic pH). Such coatings may be obtained from hydrophilic monomers of 2-hydroxyethyl methacrylate and from monomers which have chemical groups that are ionizable in an aqueous solution, such as acrylic groups.

The polymer coating may be synthesized in situ or ex situ according to the polymerization and grafting techniques well known to those skilled in the art.

The reactive polymer coating that can be used according to the invention may, for example, be prepared in situ by bringing the surface to be coated into contact with a solution containing the monomers corresponding to the polymers that it is desired to obtain, and then polymerizing, in situ, according to the conventional polymerization techniques commonly used by those skilled in the art, said surface naturally comprising, or having been prefunctionalized with, chemical groups capable of covalently bonding to one end of the monomers. The polymer coating may also be prepared from polymers that are already formed, i.e. presynthesized ex situ, in which case, the inner surface of the capillary tube is brought into contact with a solution of polymers already formed in order to allow them to be covalently grafted onto the inner surface naturally comprising, or having been prefunctionalized with, chemical groups capable of bonding to only one end of the polymer chains.

By virtue of the use of the reactive polymer coating which has just been described above, it is therefore possible to reversibly vary the viscosity of the aqueous solution of electrolytes in a double electric layer of a micro- or nanofluidic device, and thus to control the electrokinetic flows.

Thus, a second subject of the present invention is a method for reversibly varying and controlling the electrokinetic flows in a micro- or nanofluidic device comprising at least one channel or at least one capillary tube capable of containing an aqueous solution of electrolytes, characterized in that it comprises at least the following steps:

i) forming a reactive polymer coating on at least a part of the inner surface of said channel or of said capillary tube, said surface comprising electrically charged chemical groups forming a double electric layer at the liquid-solid interface, said coating being as defined above,
ii) increasing and/or decreasing the viscosity of the aqueous solution of electrolytes only in the double electric layer by activating and/or inactivating said coating by application of an external stimulation of physical or chemical nature.

According to a first embodiment, it is a method for increasing the electrokinetic flows and step ii) is an activation step. In this case, the polymer coating preferably consists of polymers sensitive to variations in temperature and the activation is carried out by heating the aqueous solution of electrolytes to a temperature above the LCST of the polymers constituting the coating. According to a most particularly preferred embodiment of the invention, the reactive coating consists of PNIPAM polymers and the activation is carried out by heating the aqueous solution of electrolytes to a temperature slightly above approximately 32° C., preferably to a temperature of between approximately 35 and 50° C.

According to a second embodiment of the present invention, it is a method for decreasing the electrokinetic flows and step ii) is an inactivation step. In this case, the polymer coating preferably consists of polymers sensitive to variations in temperature and the inactivation is carried out by cooling the aqueous solution of electrolytes to a temperature below the LCST of the polymers constituting the coating. According to a most particularly preferred embodiment of the invention, the reactive coating consists of PNIPAM polymers and the inactivation is carried out by cooling the electrophoretic solution to a temperature slightly below 32° C., preferably to a temperature of between approximately 15 and 30° C.

Finally, a last subject of the invention is a micro- or nanofluidic device, characterized in that it comprises at least one channel or at least one capillary tube, at least a part of the inner surface of which is electrically charged and covered with a reactive polymer coating as described above.

A micro- or nanofluidic device that is particularly preferred according to the invention is a device in which the reactive coating consists of polymers sensitive to an external stimulation of physical nature, and in particular to variations in temperature, such as polymers of PNIPAM type.

Thus, the micro- or nanofluidic device in accordance with the invention is preferably equipped with means for reversibly varying and controlling, locally or overall, the temperature of an aqueous solution of electrolytes present in the channel or the capillary tube (heating and/or cooling means).

The channel or the capillary tube of the micro- or nanofluidic device in accordance with the invention may normally, for example, be connected to at least two reservoirs which contain an aqueous solution of electrolytes, it being possible for said solutions to be identical or different from one reservoir to the other, and also to electrodes for applying an electric potential across the channel or the capillary tube. The channel or the capillary tube of the device in accordance with the invention can also normally be connected, at one of its ends, to a reservoir containing an aqueous solution of electrolytes and, at the other end, to a mass spectrometer. Finally, the channel or capillary tube may be part of a micro- or nanofluidic device comprising a plurality of reservoirs containing aqueous solutions of electrolytes that may be identical to or different than one another, and a plurality of electrodes.

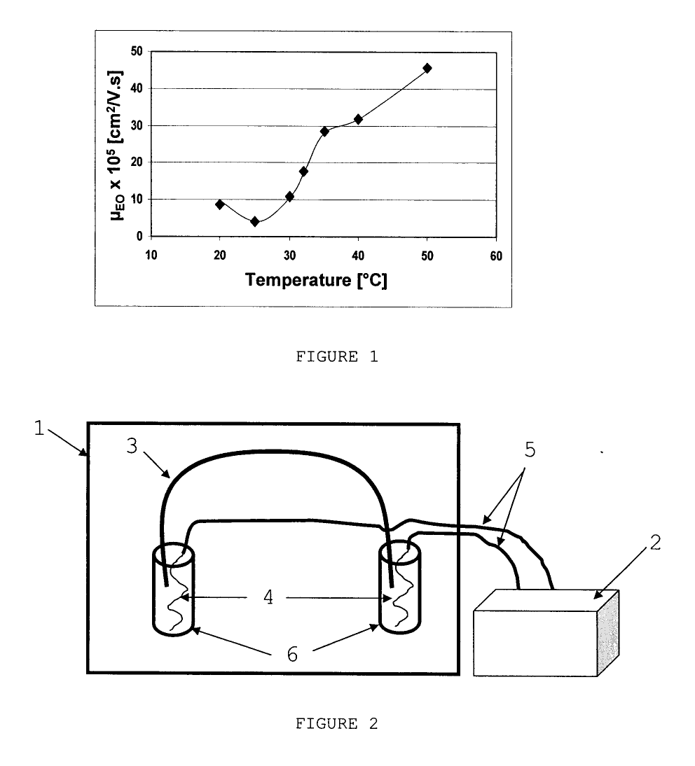

In addition to the above arrangements, the invention also comprises other arrangements which will emerge from the description which follows, which refers to examples of preparation of silica glass capillary tubes, the inner surface of which comprises a reactive polymer coating according to the invention, and also to the attached FIGS. 1 to 5 in which:

FIG. 1 represents the speed of the electroosmotic flow expressed in cm²/V·s. as a function of the temperature expressed in ° C., in a silica glass capillary tube, the inner surface of which comprises a PNIPAM-based polymer coating;

FIG. 2 is a schematic representation of a micro- or nanofluidic device in accordance with the invention. This device consists of an oven 1 equipped with a high-voltage supply 2 connected to two platinum electrodes 4 each immersed in a plastic reservoir 6 filled with a buffer solution, said platinum electrodes 4 being connected to the supply 2 by means of high-tension cables 5; the two reservoirs are connected to one another by a silica glass capillary tube 3, each of the ends of which are immersed in an aqueous solution of electrolytes, contained in the reservoirs 6. The inner surface of the capillary tube 3 is covered with a PNIPAM-type polymer coating;

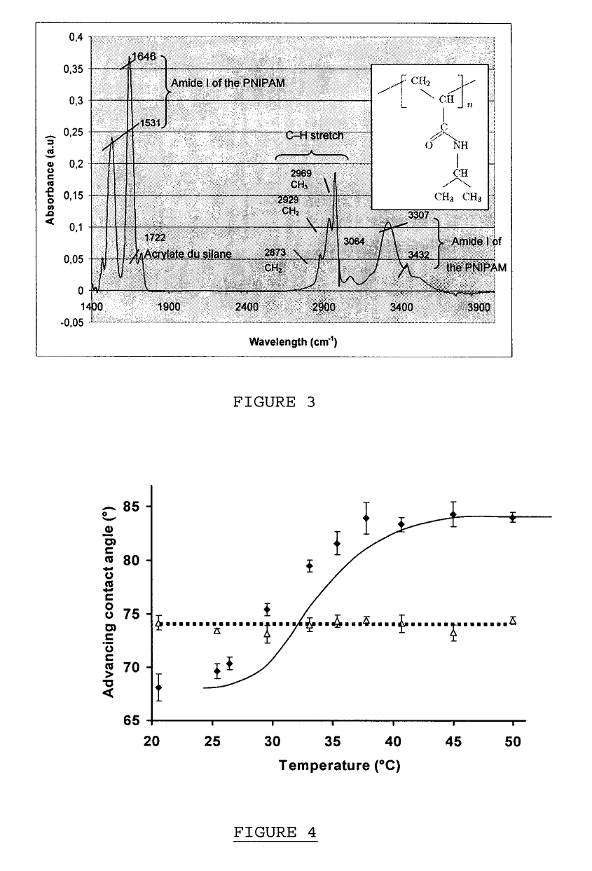

FIG. 3 represents the infrared (IR) spectrum of a PNIPAM-based polymer coating grafted onto a silica surface, on which the absorbance expressed in arbitrary units is as a function of the wavelength expressed in cm⁻¹;

FIG. 4 represents the evolution of the advancing contact angle of water as a function of the temperature on a surface grafted with a silicone layer (open triangles) and on a surface grafted with a PNIPAM-based polymer coating (solid diamonds);

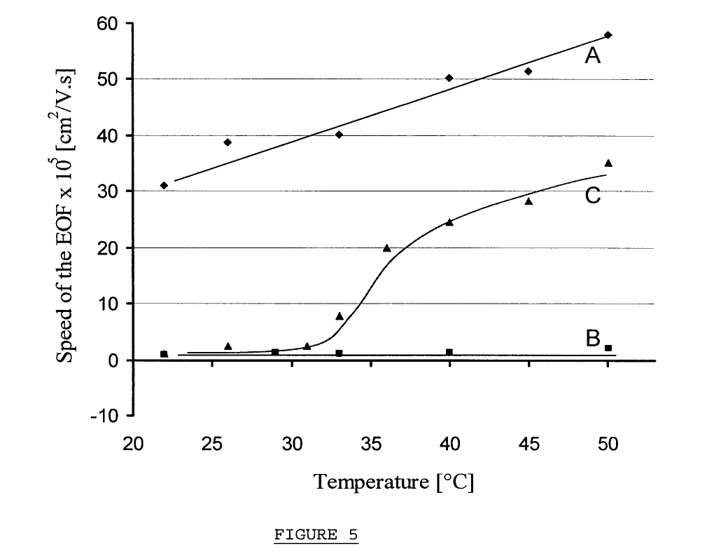

FIG. 5 represents the speed of the electroosmotic flow expressed in cm²/V·s. as a function of the temperature expressed in ° C., in a nontreated silica glass capillary tube (solid diamonds), in a silica glass capillary tube, the inner surface of which comprises a polyacrylamide polymer coating (solid squares) and in a silica glass capillary tube, the inner surface of which comprises a PNIPAM-based polymer coating (solid triangles).

### EXAMPLE 1

### Preparation of a Silica Glass Capillary Tube Comprising an Inner Surface Covered with a PNIPAM-Type Polymer Coating

This example, and also FIG. 1, relate to the application of a PNIPAM-type polymer coating onto the inner surface of a silica glass electrophoresis capillary tube (capillary tube sold by the company Polymicro Technology, L.L.C.) having an inner diameter of 100 μm and an outer diameter of 365 μm, and also its use for varying the viscosity of an aqueous solution of electrolytes in the double electric layer by external stimulation, and thus controlling the electroosmotic flow.

### 1) Preparation of the Capillary Tube: Formation of the Polymer Coating

The polymer coating was synthesized from monomers of N-isopropylacrylamide (NIPAM) sold under the reference 415324 by the company Sigma-Aldrich. The capillary tube was washed with a solution of sodium hydroxide (0.2M) for 2 hours, and then a solution of hydrochloric acid (0.2M) also for 2 hours and, finally, with deionized water (sold under the trade name MiliQ by the company Millipore) for 30 minutes.

The capillary tube was then dried in an oven at a temperature of 80° C. for 2 hours, and rinsed with ethanol for 30 minutes and then with trichloroethylene for 30 minutes.

The inner surface of the capillary tube was then silanized with a 10% (weight/volume: w/v) solution of 3-(trimethoxysilyl)propyl methacrylate (sold under the reference M6514 by the company Sigma-Aldrich) in trichloroethylene, for 2 hours.

After silanization, the capillary tube was washed with trichloroethylene (30 minutes), ethanol (30 minutes) and deionized water.

10 ml of a 10% w/v (0.88M) solution of NIPAM in deionized water was then prepared and saturated with nitrogen for 3 hours. The radical polymerization of the NIPAM was initiated with a redox couple consisting of sodium metabisulfite (NaMBS) (sold under the reference S1516 by the company Sigma-Aldrich) and ammonium persulfate (APS) (sold under the reference 431532 by the company Sigma-Aldrich). To do this, 1.11 mg of NaMBS in 110 μl of deionized water ([NIPAM]/[NaMBS] concentration ratio=0.00065) and 2.21 mg of APS in 110 μl of deionized water ([NIPAM]/[APS] concentration ratio=0.001) were added to the monomer solution. The mixture was carefully stirred and then rapidly injected into the capillary tube. The polymerization was carried out for 3 hours at a temperature of 25° C. The viscosity of the solution increased during the polymerization reaction, indicating the formation of polymers in solution.

The capillary tube was then washed with deionized water at the end of the polymerization reaction.

### 2) Measurement of the Electroosmotic Flow

The electroosmotic flow in the capillary tube thus obtained, i.e. the inner surface of which was covered with a PNIPAM-type polymer coating according to step 1) above, was measured on a capillary electrophoresis apparatus sold under the trade name P/ACE MDQ® by the company Beckmam-Coulter. Acetone was used as neutral marker for measuring the electroosmotic flow, it being possible to detect this compound by UV absorbance at a wavelength of 280 nm. The total length of the capillary tube in the P/ACE MDQ® apparatus was 33 cm and the distance between the injection point and the detection point was 20 cm. The electroosmotic flow was measured according to the method known as the “three-peak method” (Williams, B. A., Vigh, G., Anal. Chem., 1996, 68, 1174-1180), for temperatures below 30° C. The three-peak method is normally used to measure low electroosmotic flows. To measure the electroosmotic flow at temperatures above 30° C., a single-peak method was used, i.e. by measuring the migration time for the acetone marker between the injection point and the detection point for a given electrical current.

The speed of the electroosmotic flow μ_{EO}, expressed in cm²/V·s, was calculated by applying the following equation:

μ_{EO}=x/t·E

and which x is the distance between the injection point and the detection point (in this case 20 cm); t is the migration time and E is the intensity of the electric field.

The results obtained are represented in the attached FIG. 1, in which the speed of the electroosmotic flow expressed in cm²/V·s is as a function of the temperature expressed in ° C.

These results show that the electroosmotic flow is relatively constant up to the temperature of approximately 30° C., whereas, above this temperature, the electroosmotic mobility rapidly increases. The ratio between the electroosmotic mobility at low temperature (approximately 20° C.) and at high temperature (approximately 40° C.) is of the order of 3. These results demonstrate that the presence of the polymer coating on the inner wall of the capillary tube makes it possible to vary the viscosity of the aqueous solution of electrolytes in the double electric layer according to the temperature, in order to modulate the electroosmotic flow.

### EXAMPLE 2

### Preparation of Silica Glass Capillary Tubes Comprising an Inner Surface Covered with a Polymer Coating

This example relates to the control of the electroosmotic flow in a microfluidic device in accordance with the invention comprising a silica glass capillary tube (capillary tube sold by the company Polymicro Technology, L.L.C.; inner diameter: 76 μm; outer diameter: 365 μm; length: 6 cm) by virtue of the use of polymer coatings on the inner surface of the capillary tube which make it possible to vary the viscosity of the solution in the double electric layer after external activation.

### 1) Preparation of the Capillary Tube: Formation of the Polymer Coating

The polymer coating was synthesized from the same N-isopropylacrylamide (NIPAM) monomers as those used above in example 1. In this example, and unless otherwise indicated, the reactants used are the same as those used above in example 1.

The capillary tube was washed with a solution of sodium hydroxide (0.5M) for 2 hours, then a solution of hydrochloric acid (0.5M) also for 2 hours, with deionized water for 30 minutes and, finally, with ethanol for 30 minutes.

The capillary tube was then dried in an oven at a temperature of 80° C. for 2 hours and then rinsed with ethanol for 30 minutes.

The inner surface of the capillary tube was then silanized for 2 hours with a solution of ethanol containing 10% w/v (0.4M) of 3-(trimethoxysilyl)propyl methacrylate and 10% w/v (0.45M) of 3-aminopropyltriethoxysilane (sold under the reference 09324 by the company Sigma-Aldrich).

After silanization, the capillary tube was washed with ethanol (30 minutes) and dried in an incubator at a temperature of 110° C. for 30 minutes.

5 ml of a 5% w/v (0.44M) solution of NIPAM in deionized water was then prepared and saturated with nitrogen for 3 hours.

The radical polymerization of the NIPAM was initiated with a mixture of APS and N,N,N′,N′-tetramethyl-ethylenediamine (TEMED). To do this, 25 mg of APS (5 mg/ml) and 5 μl of TEMED (1 μl/ml) were added to the monomer solution. The final concentrations of APS and of TEMED in the monomer solution were 22 mM and 6.7 mM, respectively. The mixture was carefully stirred and then rapidly injected into the capillary tube. The polymerization was carried out for 3 hours at a temperature of 25° C. The viscosity of the solution increased during the polymerization reaction, indicating the formation of polymers in solution.

The capillary tube was then washed with deionized water at the end of the polymerization reaction.

### 2) Measurement of the Electroosmotic Flow

The electroosmotic flow in the capillary tube thus obtained, i.e. the inner surface of which was covered with a PNIPAM-type polymer coating according to step 1) above, was measured on a microfluidic device as represented schematically in the attached FIG. 2.

In this figure, it can be seen that this device consists of an oven 1 sold under the trade name Salvis-Lab® Vacucenter by the company Salvis (Switzerland), equipped with a high-voltage supply 2 sold under the reference HVS448 3000D by the company LabSmith, connected to two platinum electrodes 4 sold by the company GoodFellow (USA), each immersed in a plastic reservoir 6 of Eppendorf type having a volume of 1.5 ml and filled with a buffer solution, said platinum electrodes being connected to the supply 2 by means of high-tension cables 5; the two reservoirs are connected to one another by a silica glass capillary tube 3 having an inner diameter of 76 μm, an outer diameter of 365 μm and a length of 5 cm (Polymicro Technology L.L.C., USA), each of the ends of which is immersed in the buffer solution contained in the reservoirs 6.

The capillary tube 3, the reservoirs 6 of buffer solution and the electrodes 4 were enclosed in the oven 1 in order to be able to work at given temperatures (at 60° C. and at 20° C.). The inlet buffer reservoir was filled with a weakly concentrated citric acid buffer (25 mM), the pH of which was adjusted to 3 with sodium hydroxide, while the outlet buffer reservoir and the capillary tube 3 were filled with a highly concentrated citric acid buffer (50 mM), the pH of which was adjusted to 3 with sodium hydroxide. The inner wall of the capillary tube 3 was positively charged at this pH given the presence of the 3-aminopropyltriethoxysilane grafted to the surface. The application of a positive potential (200 V/cm of capillary tube) to the inlet buffer reservoir created an electroosmotic flow, allowing the weakly concentrated buffer to be pumped into the capillary tube 3. The intensity of the electric current decreased evenly until the capillary tube 3 was completely filled with the weakly concentrated buffer. The time required to replace, in the capillary tube 3, the highly concentrated buffer with the weakly concentrated buffer was measured and the speed of the electroosmotic flow as a function of the temperature (at 60° C. and at 20° C.) was calculated using the following equation (eq. 8):

μ_{EO}=X/t·E (eq. 8)

in which X is the length of the capillary tube in cm, t is the time taken to replace the highly concentrated citric acid solution (50 mM) with the weakly concentrated citric acid solution (25 mM) in the capillary tube, and E is the intensity of the electric field.

By way of a control, the same experiment was carried out at 60° C. with a capillary tube comprising no polymer coating.

The speed of the electroosmotic flow measured at 60° C. was 0.78±0.04×10⁻⁵ cm²V·s, whereas it was 0.14±0.02×10⁻⁵ cm²V·s at 20° C. These results show that the mobility of the electroosmotic flow increased by a factor of approximately 5.6 when the temperature of the buffer became higher than the LCST of the polymers constituting the coating of the inner wall of the capillary tube. The measurement carried out on the control capillary tube (without PNIPAM coating) at 60° C. gives an electroosmotic flow mobility equal to 2.18±0.04×10⁻⁵ cm²V·s. Consequently, the mobility of the electroosmotic flow in the control capillary tube (without PNIPAM coating) was approximately 2.8 times higher than that measured at 60° C. in the capillary tube comprising the PNIPAM polymer coating. Without wishing to be bound to any theory, this result may be due to screening of the surface charges by the collapsed PNIPAM chains.

### EXAMPLE 3

### Preparation of a Silica-Based Surface Covered with a PNIPAM Polymer Coating

A silica surface (1.5×7.5 cm) was covered with a PNIPAM polymer coating according to the protocol described above in example 2, step 1).

The infrared (IR) spectrum of the surface thus obtained was measured with a spectrometer sold under the trade name Equinox® IFS 55 FT-IR by the company Bruker Optics Inc. (USA, Billerica, Mass.), adapted for the laboratory. This spectrometer makes it possible to record multiple internal reflection (MIR) IR spectra. The spectrum obtained is shown in the attached FIG. 3, in which the absorbance (in arbitrary units) is expressed as a function of the wavelength (in cm⁻¹).

### EXAMPLE 4

### Preparation of Glass Plates Comprising a Surface Covered with a PNIPAM Polymer Coating

In this example, the surface of a glass plate (size 1×2 cm) was coated with a PNIPAM coating according to the protocol described above in example 2, step 1).

By way of comparison, the surface of an identical glass plate was simply silanized for 2 hours with a solution of trichloroethylene containing 10% w/v (0.4M) of 3-(trimethoxysilyl)propyl methacrylate (sold under the reference 64210 by the company Sigma-Aldrich).

After the silanization, the glass plate was washed with ethanol (30 minutes) and dried in an incubator at a temperature of 110° C. for 30 minutes.

A drop of water was deposited on each of the glass plates thus prepared, and dynamic contact angle measurements were carried out using an apparatus which makes it possible to deposit the drops manually and to measure the contact angles, sold under the trade name Digidrop® by the company GBX (France).

The measurements obtained on each of the surfaces are given in the attached FIG. 4, in which the evolution of the advancing contact angle (in °) is expressed as a function of the temperature (in ° C.): surface silanized only (open triangles) and surface with PNIPAM coating (solid diamonds).

These results show that, on the glass surface silanized only, the advancing contact angle of the drop of water remains constant despite the increase in the temperature, whereas, on the surface comprising the PNIPAM coating in accordance with the invention, this angle varies as a function of the temperature.

### EXAMPLE 5

### Preparation of Silica Glass Capillary Tubes Comprising a Surface Covered with a PNIPAM-Type Polymer Coating

The aim of this example is to compare the variations in the electroosmotic flows in several capillary tubes:
Capillary tube A: control capillary tube, not functionalized;
Capillary tube B: capillary tube, the inner surface of which is covered with a polyacrylamide-type coating;
Capillary tube C: capillary tube in accordance with the invention, i.e. the inner surface of which is covered with a PNIPAM polymer coating.

In this example, the same silica glass electrophoresis capillary tubes as those described in example 2 above were used.

Before they were used, these capillary tubes were washed with a 0.2M sodium hydroxide solution for 30 minutes and then with a 0.2M hydrochloric acid solution for 30 minutes and, finally, with deionized water (sold under the trade name MiliQ by the company Millipore) also for 30 minutes.

The capillary tubes were then dried in an incubator at a temperature of 80° C. for 2 hours, and then rinsed with ethanol for 30 minutes.

Capillary tube A was subjected to no further treatment.

The inner surface of capillary tube C was then silanized and covered with a PNIPAM coating according to the protocol described above in example 2, step 1.

The inner surface of capillary tube B was silanized and covered with a polyacrylamide coating according to the same protocol as that used for capillary tube C, but using acrylamide in place of the NIPAM.

The measurements of the speed of the electroosmotic flow in capillary tubes A, B and C were carried out according to the method described above in example 2 (2—Measurement of the electroosmotic flow).

The results obtained are reported in the attached FIG. 5, in which the speed of the electroosmotic flow expressed in cm²/V·s is as a function of the temperature expressed in ° C.: capillary tube A: solid diamonds, capillary tube B: solid squares, capillary tube C: solid triangles.

It is noted that, in capillary tube A, the speed of the electroosmotic flow increases in a linear manner as a function of the temperature. In capillary tube B, not in accordance with the present invention since it comprises a polyacrylamide-type coating, no variation in the electroosmotic flow is observed as a function of the temperature, the flow being nonexistent.

Conversely, in capillary tube C, in accordance with the present invention, i.e. comprising an inner PNIPAM coating, it is noted that the electroosmotic flow is nonexistent up to a temperature of approximately 30° C., and that, from this point onward, the increase in the temperature brings about a very rapid increase in the electroosmotic flow. The presence of the PNIPAM polymer coating on the inner wall of capillary tube C makes it possible to block and then to vary the electroosmotic flow, which is not possible in capillary tubes A and B which are not part of the invention.

1. The method of using a reactive polymer coating grafted onto at least a part of the inner surface of a channel or of a capillary tube of a micro- or nanofluidic device containing at least one aqueous solution of electrolytes, said surface comprising electrically charged chemical groups forming a double electric layer at the liquid-solid interface, said coating having the following characteristics:
a) it consists of a layer of flexible polymers capable of undergoing phase separation (coil-globule transition) in an aqueous solution under the influence of an external stimulation of physical or chemical nature,
b) the polymers are covalently grafted onto said surface via just one of their ends,
for reversibly modulating and controlling the electrokinetic flows in said device by varying the viscosity of the aqueous solution of electrolytes only in the double electric layer under the influence of an external activation of chemical or physical nature.

2. The method as claimed in claim 1, characterized in that the thickness of the double electric layer present at the interface of the electrophoresis device is between 0.1 nm and 1 μm.

3. The method as claimed in claim 1, characterized in that the inner surface is chosen from glass, quartz, silica and polymer materials.

4. The method as claimed in claim 1, characterized in that the channel and the capillary tube have dimensions such that their smallest width or their diameter is greater than the thickness of the double electric layer.

5. The method as claimed in claim 1, characterized in that the chemical groups are chosen from silanol groups when the inner surface is a hydrated silica oxide, quartz or glass; primary, secondary or tertiary amines; sulfate, sulfonate, phosphonate and carboxylic groups.

6. The method as claimed in claim 1, characterized in that the polymers are covalently grafted onto the inner surface of said channel or said capillary tube by means of chemical groups chosen from silanol, vinyl, carboxyl, amino, epoxy, oxyamine, thiol and halide groups.

7. The method as claimed in claim 5, characterized in that the inner surface of the channel or of the capillary tube is modified with at least two types of chemical groups of different nature.

8. The method as claimed in claim 1, characterized in that the polymers are inactivated and in that the thickness of the reactive polymer coating is greater than that of the double electric layer.

9. The method as claimed in claim 8, characterized in that, when an electric field is applied to the device, the electrokinetic flow of the aqueous solution of electrolytes tends toward zero.

10. The method as claimed in claim 1, characterized in that the polymers are activated and in that the thickness of the polymer coating is less than that of the double electric layer.

11. The method as claimed in claim 10, characterized in that, when an electric field is applied to the device, the electrokinetic flow of the aqueous solution of electrolytes is other than zero, and proportional to the surface potential.

12. The method as claimed in claim 1, characterized in that the grafting density of the polymers is such that the polymers are in the form of a discontinuous and heterogeneous coating when the polymers are in the collapsed state and form holes which allow the surface charges to be exposed to the aqueous solution of electrolytes.

13. The method as claimed in claim 1, characterized in that the polymer coating consists of polymers sensitive to variations in temperature and chosen from poly(N-isopropylacrylamide), poly(N,N′-methylpropylacrylamide), poly(N-propylacrylamide), poly(N,N′-methylethylacrylamide), poly(N-propylmethacrylamide), poly(N,N′-isopropylmethacrylamide); copolymers resulting from the copolymerization of monomers chosen from N-isopropylacrylamide, N,N′-methylpropylacrylamide, N-propylacrylamide, N,N′-methyl-ethylacrylamide, N-propylmethacrylamide and N,N′-isopropylmethacrylamide; copolymers resulting from the copolymerization of a monomer chosen from N-isopropylacrylamide, N,N′-methylpropylacrylamide, N-propylacrylamide, N,N′-methylethylacrylamide, N-propyl-methacrylamide and N,N′-isopropylmethacrylamide and of a monomer not sensitive to external variations of chemical or physical nature, chosen from acrylamide, N,N-dimethyl-acrylamide, acrylic acid and acrylamide-type monomers; and block copolymers of polyethylene oxide, of polypropylene oxide and of methylcellulose.

14. The method as claimed in claim 1, characterized in that the polymer coating consists of polymers sensitive to irradiation by light, comprising an azobenzene unit and chosen from copolymers of N-isopropylacrylamide and of N-(4-(phenylazo)phenyl)acrylamide and copolymers of dimethylacrylamide and of phenylazophenyl acrylate.

15. The method as claimed in claim 1, characterized in that the polymer coating consists of polymers sensitive to a variation in pH and chosen from polymers obtained from hydrophilic monomers of 2-hydroxyethyl methacrylate and from acrylic monomers.

16. A method for reversibly varying and controlling the electrokinetic flows in a micro- or nanofluidic device comprising at least one channel or at least one capillary tube capable of containing an aqueous solution of electrolytes, characterized in that it comprises at least the following steps:
i) forming a reactive polymer coating on at least a part of the inner surface of said channel or of said capillary tube, said surface comprising electrically charged chemical groups forming a double electric layer at the liquid-solid interface, said coating being as defined in claim 1;
ii) increasing and/or decreasing the viscosity of the aqueous solution of electrolytes only in the double electric layer by activating and/or inactivating said coating by application of an external stimulation of physical or chemical nature.

17. The method as claimed in claim 16, characterized in that it is a method for increasing the electrokinetic flows and in that step ii) is an activation step.

18. The method as claimed in claim 17, characterized in that the coating consists of polymers sensitive to variations in temperature and in that the activation is carried out by heating the aqueous solution of electrolytes to a temperature above the LCST of the polymers constituting the coating.

19. The method as claimed in claim 16, characterized in that it is a method for decreasing the electrokinetic flows and in that step ii) is an inactivation step.

20. The method as claimed in claim 19, characterized in that the coating consists of polymers sensitive to variations in temperature and the inactivation is carried out by cooling the aqueous solution of electrolytes to a temperature below the LCST of the polymers constituting the coating.

21. A micro- or nanofluidic device, characterized in that it comprises at least one channel or at least one capillary tube, at least a part of the inner surface of which is electrically charged and covered with a reactive polymer coating as defined in claim 1.

22. The device as claimed in claim 21, characterized in that the reactive polymer coating consists of polymers sensitive to variations in temperature and in that it is equipped with means for reversibly varying and controlling, locally or overall, the temperature of an aqueous solution of electrolytes present in said channel or said capillary tube.
